(19) United States
(12) Patent Application Publication
(10) Pub. No.: US 2022/0075068 A1
(43) Pub. Date: Mar. 10, 2022

(54) DECISION-BASED SENSOR FUSION WITH GLOBAL OPTIMIZATION FOR INDOOR MAPPING

(71) Applicants: Chen Liu, Potsdam, NY (US); Zhiliu Yang, Potsdam, NY (US); Shaoshan Liu, Fremont, CA (US)

(72) Inventors: Chen Liu, Potsdam, NY (US); Zhiliu Yang, Potsdam, NY (US); Shaoshan Liu, Fremont, CA (US)

(73) Assignee: CLARKSON UNIVERSITY, Potsdam, NY (US)

(21) Appl. No.: 17/472,027

(22) Filed: Sep. 10, 2021

Related U.S. Application Data
(60) Provisional application No. 63/076,508, filed on Sep. 10, 2020.

(51) Int. Cl. G01S 17/89; G05D 1/02; G01S 15/86; G01S 17/58

(52) U.S. Cl. CPC G01S 17/89; G05D 1/0251; G01S 17/58; G01S 15/86; G05D 1/0248

(57) ABSTRACT

A tightly coupled fusion approach that dynamically consumes light detection and ranging (LiDAR) and sonar data to generate reliable and scalable indoor maps for autonomous robot navigation. The approach may be used for the ubiquitous deployment of indoor robots that require the availability of affordable, reliable, and scalable indoor maps. A key feature of the approach is the utilization of a fusion mechanism that works in three stages: the first LiDAR scan matching stage efficiently generates initial key localization poses; a second optimization stage is used to eliminate errors accumulated from the previous stage and guarantees that accurate large-scale maps can be generated; and a final revisit scan fusion stage effectively fuses the LiDAR map and the sonar map to generate a highly accurate representation of the indoor environment.

### CROSS-REFERENCE TO RELATED APPLICATIONS

The present application claims priority to U.S. Nonprovisional Application No. 63/076,508 filed on Sep. 10, 2020, hereby incorporated by reference in its entirety.

### BACKGROUND OF THE INVENTION

### 1. Field of the Invention

The present invention relates to indoor mapping systems and, more specifically, a system that employs tightly coupled decision-based fusion of light detection and ranging (LiDAR) and sonar data.

### 2. Description of the Related Art

A 2D base map is one of the most essential elements for indoor mobile robots. LiDAR sensors, though very popular in indoor mapping, cannot be used to generate precise indoor maps due to their inability to handle reflective objects, such as glass doors and French windows. Although several approaches to overcoming this problem use high-end LiDAR sensors and signal processing techniques, the cost of these high-end LiDAR sensors can be prohibitive for large-scale deployment of indoor robots. Similarly, sonar sensors have been used to construct indoor maps as well. But sonar-based maps suffer from inaccuracy caused by sonar crosstalk, corner effects, large noise, etc. Although combining these approaches would seem logical, previous fusion attempts usually focus on one particular usage scenario and are unable to generate accurate maps and handle large areas.

In using sonar range finder to compensate LiDAR scanning, especially for glass detection, fusion has been one of the main techniques to obtain the location of glass materials. One way is to fuse sonar readings and laser scans in a Kalman filter fashion, where line segment and corner are used as features for sonar and laser synergy. However, the precision and density of this generated map is not sufficient to support robot navigation. Both pre-fusion and post-fusion methods for glass detection have not solved these problems. The pre-fusion method is to filter sonar and laser data before localization, while the post-fusion one is to conduct localization with laser data separately, then overlapping with sonar results. For example, fusion has been used to detect glass via subtracting the detected range of sonar and LiDAR. This approach is able to produce glass-aware map in small-area environment, but cannot handle large-area environments as the noise of sonar for non-glass area degrades overall LiDAR mapping results, and thus cannot be used for ubiquitous deployment. Another distinct technique for glass detection is to analyze the features of reflected laser intensity, where different methods were proposed to localize glass area with pure LiDAR sensing. This method suffers from affordability as it requires high-precision hence expensive LiDAR to guarantee the sensitivity of detection, and its effectiveness in large-area mapping remains unknown. Accordingly, there is a need in the art for an approach that can employ LiDAR and sonar data to create a reliable map in large scale indoor environment with a high proportion of repetitive areas.

### BRIEF SUMMARY OF THE INVENTION

The present invention comprises tightly coupled decision-based fusion of LiDAR and sonar data that effectively detects glass walls/panels, eliminates unknown space caused by range limits of LiDAR, and enrolls global optimization into the fusion. More specifically, the present invention uses a post-accumulation decision-based map fusion strategy that aims to obtain higher mapping quality by utilizing precise localization result of 2D LiDAR point cloud and effective perception compensation of sonar range data. The present invention can produce a reliable and scalable map for mobile robot navigation in both small-scale and large-scale indoor environments. A revisit scan may be provided to fuse the LiDAR map and the sonar map in the pixel level to generate a highly accurate representation for both small-area and large-area real-world environments with various degrees of reflective material.

In a first embodiment, the present invention comprises a method for mapping an indoor space involving the steps of obtaining LiDAR sensor data from an indoor space to be mapped, obtaining sonar data from the indoor space to be mapped, performing pose estimation using the LiDAR sensor data to generate a LiDAR map, performing grid registration and updating using the sonar data and estimated poses to generate a sonar map, and fusing the LiDAR map and the sonar map to generate a final map of the indoor space. The step of performing pose estimation using the LiDAR sensor data may comprise performing local scan matching to transform the LiDAR sensor data to a map frame comprising a plurality of submaps using scan poses. The step of performing pose estimation using the LiDAR sensor data may comprise extracting an initial local pose from a predetermined motion model to identify a plurality of key nodes. The step of performing pose estimation using the LiDAR sensor data may comprise matching the plurality of key nodes to one of the plurality of submaps until the number of matched key nodes exceed a predetermined threshold and then matching the plurality of key nodes to another of the plurality of submaps. The step of performing pose estimation using the LiDAR sensor data may comprise optimizing the plurality of submaps and corresponding matched key nodes to produce a final global pose. The step of fusing the LiDAR map and the sonar map may comprise performing trajectory fitting to generate a final fitted global pose. The step of performing grid registration and updating may comprise mapping the sonar data uses the final fitted global pose. The step of fusing the LiDAR map and the sonar map may comprise performing a second scan at a pixel level of the LiDAR map and the sonar map following the fitted final global pose. The step of performing a second scan at a pixel level of the LiDAR map and the sonar map following the fitted final global pose may comprise casting a plurality of rays from a sensor origin to a boundary of the LiDAR map and the sonar map to record a first occupied grid positioned along each of the plurality of rays. The step of performing a second scan at a pixel level of the LiDAR map and the sonar map following the fitted final global pose may comprise determining distances between obstacles in the LiDAR map and the sonar map using the first occupied grid positioned along each of the plurality of rays. The step of fusing the LiDAR map and the sonar map may comprise fusing the LiDAR map and the sonar map based on differences in the distances between obstacles in the LiDAR map and the sonar map.

In another embodiment, the present invention may be a device capable of navigating within an indoor location including a LiDAR sensor capable of outputting LiDAR data, a sonar sensor capable of outputting sonar data, and a microcontroller coupled to the sonar sensor to receive the sonar data and the LiDAR sensor to receive the LiDAR sensor data, wherein the microcontroller is programmed to construct a final map of the indoor location by performing pose estimation using the LiDAR sensor data to generate a LiDAR map, performing grid registration and updating using the sonar data and estimated posed to generate a sonar map, and fusing the LiDAR map and the sonar map to generate a final map of the indoor space. The microcontroller may be programmed to perform pose estimation using the LiDAR sensor data by performing local scan matching to transform the LiDAR sensor data to a map frame comprising a plurality of submaps using scan poses, extracting an initial local pose from a predetermined motion model to identify a plurality of key nodes, matching the plurality of key nodes to one of the plurality of submaps until the number of matched key nodes exceed a predetermined threshold and then matching the plurality of key nodes to another of the plurality of submaps, and optimizing the plurality of submaps and corresponding matched key nodes to produce a final global pose. The microcontroller may be programmed to fuse the LiDAR map and the sonar map by performing trajectory fitting to generate a final fitted global pose. The microcontroller may be programmed to perform grid registration and updating by mapping the sonar data using the final fitted global pose. The microcontroller may be programmed to fuse the LiDAR map and the sonar map by performing a second scan at a pixel level of the LiDAR map and the sonar map following the fitted final global pose. The microcontroller may be programmed to perform the second scan by casting a plurality of rays from a sensor origin to a boundary of the LiDAR map and the sonar map to record a first occupied grid positioned along each of the plurality of rays. The microcontroller may be programmed to determine distances between obstacles in the LiDAR map and the sonar map using the first occupied grid positioned along each of the plurality of rays. The microcontroller may be programmed to fuse the LiDAR map and the sonar map based on differences in the distances between obstacles in the LiDAR map and the sonar map.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a high level diagram of a mapping procedure using a fusion of LiDAR and sonar data according to the present invention;

FIG. 2 is a detailed diagram of a mapping approach using a fusion of LiDAR and sonar data according to the present invention;

FIG. 3 is a detailed visualization of a fusion of LiDAR and sonar map according to the present invention; and

FIG. 4 is a schematic of a device according to the present invention.

### DETAILED DESCRIPTION OF THE INVENTION

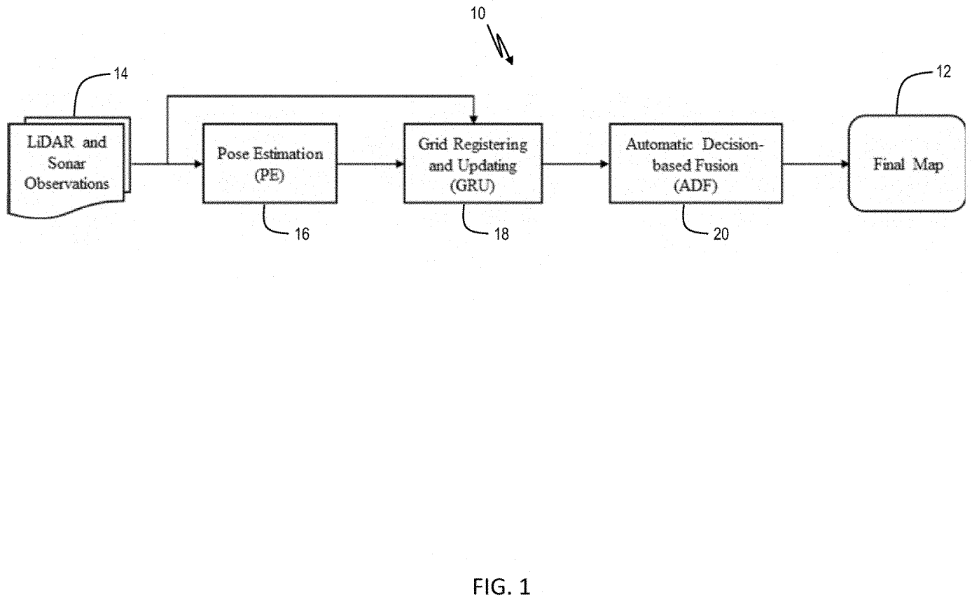

Referring to the figures wherein like numerals refer to like parts throughout, there is seen in FIG. 1 an overview of a mapping framework 10 according to the present invention. Framework 10 comprises three main processes for producing a final map 12 from LiDAR and sonar sensor data 14: Pose Estimation (PE) 16, Grid Registering and Updating (GRU) 18, and Automatic Decision-based Fusion (ADF) 20.

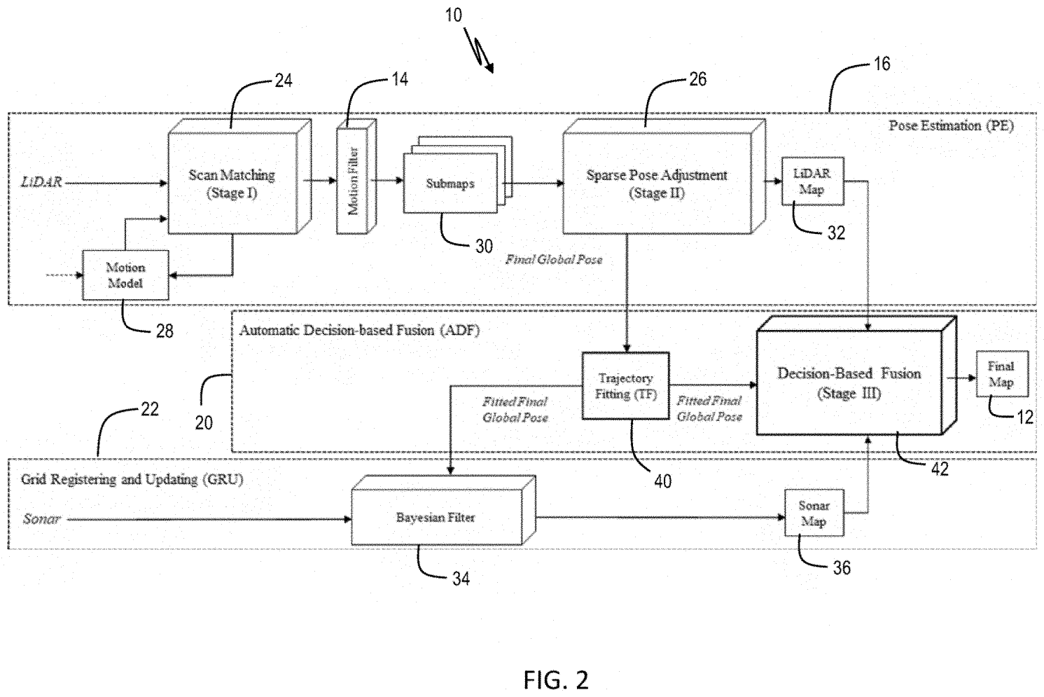

For pose estimation (PE) 16, LiDAR observation is utilized for localization in our system with LiDAR being a more-precise range finder. The precise localization is achieved by maximizing the probability of individual grid on the map, given the LiDAR observation and other outside signals. Referring to FIG. 2, pose estimation (PE) 16 comprises two stages, Local Scan Matching (Stage I) 24 and Global Loop Closure (Stage II) 26. In Stage I, raw LiDAR observations are transformed to a map frame via scan poses, and a submap 30 is used in order to eliminate the accumulation of drift error. A submap 30 is a local chunk of the whole environment and is represented in the form of an Occupancy Grid Map. As seen in FIG. 2, an initial local pose is extrapolated from the motion model 28. If the change between two consecutive scans is below a predefined threshold, the scan will be discarded, otherwise they are survived, which are defined as key nodes.

In Stage II 26, key node scans are first matched on a submap 30 sequentially. When the number of key nodes within one submap 30 reaches its limit, a matching target moves to the next candidate submap. Then, a round of optimization is launched. By following a Sparse Pose Adjustment method, a nonlinear optimization problem can be solved via considering constraints between key node poses and submap poses. Involved with global loop closure, a final global pose (FGP) is generated for the stages to follow and a LiDAR map 32 is constructed.

For Grid Registering and Updating (GRU) 22, LiDAR map 32 is constructed simultaneously with PE introduced in the previous step. All valid LiDAR scans are registered in LiDAR map based on the final global pose (FG). The mapping on the sonar side is converted to mapping with known poses, which is to obtain maximum likelihood probability of each grid on sonar map, given known poses and sonar observations. Simple sonar mapping algorithms are sufficient to meet the system requirement. For example, as seen in FIG. 2, a Bayesian Filter Algorithm (BFA) 34 may be used to process the sonar data to form a sonar map 36 by fusing multiple sonar sensor readings into OGM in a Bayesian fashion, which resolves conflicts from different readings. A cone sensor model may be applied here as well.

Automatic Decision-based Fusion (ADF) 20 comprises Trajectory Fitting (TF) 40 and Revisit Scan Fusion (Stage III) 42. As in Stage I of PE 16, only those scans surviving from scan matching and motion filter are cached as key nodes and fed to global optimization. However, Revisit Scan Fusion 42 is highly dependent on the quality of final global pose (FG), so trajectory fitting 40 is conducted for the trajectory to generate a final fitted pose (FGfit) of higher quality. Trajectory fitting 40 provides smoothing of the trajectory used by automatic Decision-Based Fusion and can be used as feedback to GRU 22 to improve sonar map density by extrapolating middle status between poses. Stage III aims to fuse LiDAR map 32 and the sonar map 36 which are constructed separately in previous stages. The fusion relies on a second scan performed at the pixel level of map images via following FGfit.

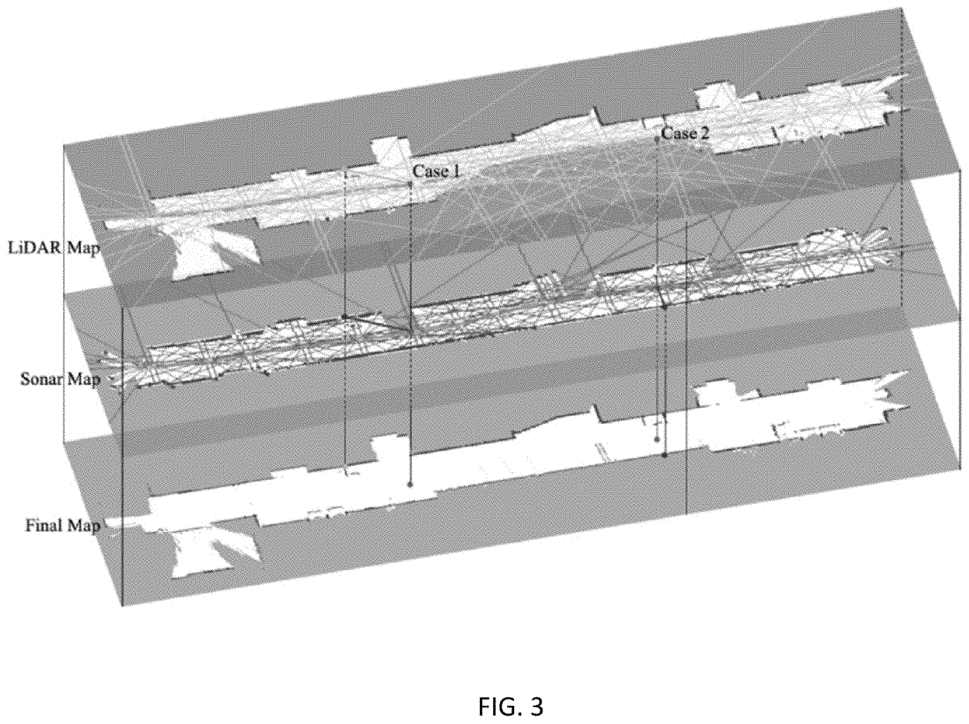

Referring to FIG. 3, rays are cast from the sensor origin along the FGfit trajectory to the boundary of maps and the first occupied grid along the ray is recorded. For each ray, the first occupied grid along the ray is the ending position of one casting. The image boundary grid is used if no occupied grid is detected along the ray. The obstacle distances for occupied grid are defined by the grid numbers between the starting point and the ending point by following Bresenham's line algorithm. For each casting ray, the difference of obstacle distances between the two maps is used to make a fuse decision. In case 1 seen in FIG. 3, the distance difference exceeds a predefined threshold, which means that the corresponding ray has hit the glass material, so grey intensity of final map along this ray is fused by sonar range data. In case 2 seen in FIG. 3, the distance difference is smaller than predefined threshold, which means the LiDAR detection is reliable. Thus, the grey intensity of final map along this ray is fused by LiDAR range data.

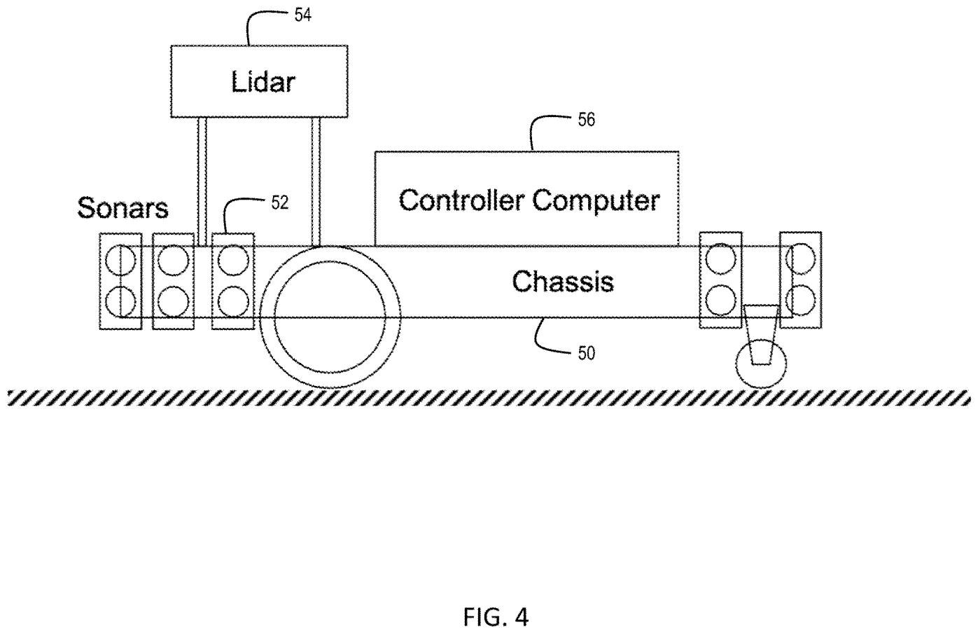

Referring to FIG. 4, a device 50, such as an indoor robot, outfitted according to the present invention includes a plurality of sonar sensors 52 and a LiDAR sensor 54 that can output LiDAR and sonar sensor data 14 to be processed as explained above. LiDAR sensor 54 may comprise a RPLIDAR-A1 2D LiDAR sensor. Sonar sensors 52 may comprise HC-SR04 Ultrasonic Module Distance Sensors. Pose Estimation (PE) 16, Grid Registering and Updating (GRU) 18, and Automatic Decision-based Fusion (ADF) 20 according to the present invention may be programmed into a controller computer 56 to generate final map 12 based on LiDAR and sonar sensor data 14. Controller computer 56 may comprise Raspberry Pi 4 Model B and device 50 may comprise a TurtleBot 3 Burger. It should be recognized that the present invention may be implemented using a variety of LiDAR sensors, sonar sensors, controller computers and robot platform/chassis.

What is claimed is:

1. A method for mapping an indoor space, comprising the steps of:
obtaining light detection and ranging (LiDAR) sensor data from an indoor space to be mapped;
obtaining sonar data from the indoor space to be mapped;
performing pose estimation using the LiDAR sensor data to generate a plurality of estimated poses and a LiDAR map;
performing grid registration and updating using the sonar data and the plurality of estimated poses to generate a sonar map; and
fusing the LiDAR map and the sonar map to generate a final map of the indoor space.

2. The method of claim 1, wherein the step of performing pose estimation using the LiDAR sensor data comprises performing local scan matching to transform the LiDAR sensor data to a map frame comprising a plurality of submaps using scan poses.

3. The method of claim 2, wherein the step of performing pose estimation using the LiDAR sensor data comprises extracting an initial local pose from a predetermined motion model to identify a plurality of key nodes.

4. The method of claim 3, wherein the step of performing pose estimation using the LiDAR sensor data comprises matching the plurality of key nodes to one of the plurality of submaps until a number of matched key nodes exceed a predetermined threshold and then matching the plurality of key nodes to another of the plurality of submaps.

5. The method of claim 4, wherein the step of performing pose estimation using the LiDAR sensor data comprises optimizing the plurality of submaps and corresponding matched key nodes to produce a final global pose.

6. The method of claim 5, wherein the step of fusing the LiDAR map and the sonar map comprises performing trajectory fitting to generate a final fitted global pose.

7. The method of claim 6, wherein the step of performing grid registration and updating comprises mapping the sonar data uses the final fitted global pose.

8. The method of claim 7, wherein the step of fusing the LiDAR map and the sonar map comprises performing a second scan at a pixel level of the LiDAR map and the sonar map following the fitted final global pose.

9. The method of claim 8, wherein the step of performing a second scan at a pixel level of the LiDAR map and the sonar map following the fitted final global pose comprises casting a plurality of rays from a sensor origin to a boundary of the LiDAR map and the sonar map to record a first occupied grid positioned along each of the plurality of rays.

10. The method of claim 9, wherein the step of performing a second scan at a pixel level of the LiDAR map and the sonar map following the fitted final global pose comprises determining distances between obstacles in the LiDAR map and the sonar map using the first occupied grid positioned along each of the plurality of rays.

11. The method of claim 10, wherein the step of fusing the LiDAR map and the sonar map comprises fusing the LiDAR map and the sonar map based on differences in the distances between obstacles in the LiDAR map and the sonar map.

12. A device capable of navigating within an indoor location, comprising:
a light detection and ranging (LiDAR) sensor capable of outputting LiDAR data;
a sonar sensor capable of outputting sonar data; and
a microcontroller coupled to the sonar sensor to receive the sonar data and to the LiDAR sensor to receive the LiDAR data, wherein the microcontroller is programmed to construct a final map of the indoor location by performing pose estimation using the LiDAR sensor data to generate a plurality of estimated poses and a LiDAR map, performing grid registration and updating using the sonar data and the plurality of estimated posed to generate a sonar map, and fusing the LiDAR map and the sonar map to generate a final map of the indoor space.

13. The device of claim 12, wherein the microcontroller is programmed to perform pose estimation using the LiDAR sensor data by performing local scan matching to transform the LiDAR sensor data to a map frame comprising a plurality of submaps using scan poses, extracting an initial local pose from a predetermined motion model to identify a plurality of key nodes, matching the plurality of key nodes to one of the plurality of submaps until a number of matched key nodes exceed a predetermined threshold and then matching the plurality of key nodes to another of the plurality of submaps, and optimizing the plurality of submaps and corresponding matched key nodes to produce a final global pose

14. The device of claim 13, wherein the microcontroller is programmed to fuse the LiDAR map and the sonar map by performing trajectory fitting to generate a final fitted global pose.

15. The device of claim 14, wherein the microcontroller is programmed to perform grid registration and updating by mapping the sonar data using the final fitted global pose.

16. The device of claim 15, wherein the microcontroller is programmed to fuse the LiDAR map and the sonar map by performing a second scan at a pixel level of the LiDAR map and the sonar map following the fitted final global pose.

17. The device of claim 16, wherein the microcontroller is programmed to perform the second scan by casting a plurality of rays from a sensor origin to a boundary of the LiDAR map and the sonar map to record a first occupied grid positioned along each of the plurality of rays.

18. The device of claim 17, wherein the microcontroller is programmed to determine distances between obstacles in the LiDAR map and the sonar map using the first occupied grid positioned along each of the plurality of rays.

19. The device of claim 18, wherein the microcontroller is programmed to fuse the LiDAR map and the sonar map based on differences in distance between obstacles in the LiDAR map and the sonar map.
